(19) United States
(12) Patent Application Publication
(10) Pub. No.: US 2008/0183855 A1
(43) Pub. Date: Jul. 31, 2008

(54) SYSTEM AND METHOD FOR PERFORMANCE PROBLEM LOCALIZATION

(75) Inventors: Manoj K. Agarwal, Noida (IN); Narendran Sachindran, New Delhi (IN); Manish Gupta, New Delhi (IN)

Correspondence Address: FREDERICK W. GIBB, III;Gibb & Rahman, LLC, 2568-A RIVA ROAD, SUITE 304, ANNAPOLIS, MD, 21401, US

(73) Assignee: International Business Machines Corporation, Armonk, NY (US)

(21) Appl. No.: 12/061,734

(22) Filed: Apr. 3, 2008

Related U.S. Application Data
(63) Continuation of application No. 11/567,240, filed on Dec. 6, 2006.

(51) Int. Cl. G06F 15/173

(52) U.S. Cl. 709/223

(57) ABSTRACT

A method and a system for resolving problems in an enterprise system which contains a plurality of servers forming a cluster coupled via a network. A central controller is configured to monitor and control the plurality of servers in the cluster. The central controller is configured to poll the plurality of servers based on pre-defined rules and identify an alarm pattern in the cluster. The alarm pattern is associated with one of the servers in the cluster and a possible root cause is identified by the central controller with labeled alarm pattern in a repository and a possible solution is recommended to overcome the identified problem that has been associated with the alarm pattern. Information in the repository is adapted based on feedback about the real root cause obtained from the administrator.

### CROSS-REFERENCE TO RELATED APPLICATIONS

This application is a continuation of U.S. application Ser. No. 11/567,240 filed Dec. 6, 2006, the complete disclosure of which, in its entirety, is herein incorporated by reference.

### FIELD OF THE INVENTION

This invention relates to a method and system for localization of performance problems in an enterprise system. More particularly, this invention relates to localization of performance problems in a enterprise system, based on supervised learning.

### BACKGROUND OF THE INVENTION

Modern enterprise systems provide services based on a service level agreement (SLA) specifications to minimum cost. Performance problems in such enterprise systems are typically manifested as high response times, low throughput, a high rejection rate of requests and the like. However, a root cause associated with these problems may be due to subtle reasons hidden in the complex stack of this execution environment. For example, a badly written application code may cause an application to hang. Also, a badly written application code may result in non availability of a connection between an application server and a database server coupled over a network, resulting in the failure of critical transactions. Moreover, badly written application code may result in a failover to backup processes, where such backup processes may result in performance degradation of servers running on that machine. Further, various components in such enterprise systems have inter dependencies, which may be temporal or non-deterministic, as they may change with changes in topology, application, or workload, further complicating the root cause localization.

Artificial Intelligence (AI) techniques such as rule-based techniques, model-based techniques, neural networks, decision trees, and model traversing techniques (e.g., dependency graphs, fault propagation techniques such as Bayesian networks and causality graphs, etc.) are commonly used in rule based systems. Hellerstein et al., Discovering actionable patterns in event data, IBM Systems Journal, Vol 41, No 3, 2002, discover patterns using association rule mining based techniques. Additionally, each fault is usually associated with a specific pattern of events. Association rule based techniques require a large number of sample instances before discovering k-item set in a large number of events. In a rule definition, all possible root causes are represented by rules specified as condition action pairs. Conditions are typically specified as logical combinations of events, which are defined by domain experts. A rule is satisfied when a combination of events raised by the management system exactly matches the rule condition. Rule based systems are popular because of the ease of use. A disadvantage of this technique is the reliance on pattern periodicity.

U.S. Pat. No. 7,062,683 discloses a two-phase method to perform root-cause analysis over an enterprise-specific fault model is described. In the first phase, an up-stream analysis is performed (beginning at a node generating an alarm event) to identify one or more nodes that may be in failure. In the second phase, a down-stream analysis is performed to identify those nodes in the enterprise whose operational condition are impacted by the prior determined failed nodes. Nodes identified as failed due to the up-stream analysis may be reported to a user as failed. Nodes impacted as a result of the down-stream analysis may be reported to a user as impacted, and beneficially, any failure alarms associated with those impacted nodes may be masked. Up-stream (phase 1) analysis is driven by inference policies associated with various nodes in the enterprise's fault model. An inference policy is a rule, or set of rules, for inferring the status or condition of a fault model node and is based on the status or condition of the node's immediately down-stream neighboring nodes. Similarly, down-stream (phase 2) analysis is driven by impact policies associated with various nodes in the enterprise's fault model. An impact policy is a rule, or set of rules, for assessing the impact on a fault model node and is based on the status or condition of the node's immediately up-stream neighboring nodes.

A disadvantage of such a rule based system is the need for domain experts to define rules. A further disadvantage of such a rule based system is that rules defined once in the system are inflexible and require exact matches, making it difficult to adapt in response to environmental changes. These disadvantages typically lead to a breach in the SLA and may also result in a significant penalty.

Without a way to improve the method and system of performance problem localization, the promise of this technology may never be fully achieved.

### SUMMARY OF THE INVENTION

A first aspect of the invention is a method for performance problems by localization of the performance problems in an enterprise system, which consists of a plurality of servers forming a cluster. The method involves monitoring the plurality of servers in the cluster for an alarm pattern. Recognizing the alarm pattern in the cluster. The alarm pattern is generated by at least one of the servers amongst the plurality of servers. The alarm pattern and the server address are received at a central controller. After receiving the alarm pattern, presenting the alarm pattern to an administrator for identifying a possible root cause to the alarm pattern, where the administrator retains a list of alarm patterns in a repository. Recommending a list of possible root causes and their associated solutions, in an order of relevance, to the administrator.

A second aspect of the invention is an enterprise system consisting of a plurality of servers coupled over a network. Each of the plurality of servers coupled being configured to perform at least one identified task assigned to the server. The cluster includes a central controller which is configured to monitor and control the plurality of servers in the cluster. When an alarm pattern is generated in the cluster, the central controller is configured to identify the alarm pattern, and a list of possible root causes and their associated solutions, in an order of relevance, to the administrator.

### BRIEF DESCRIPTION OF THE DRAWINGS

FIG. 1 illustrates an exemplary embodiment of an enterprise system in accordance with the invention.

FIG. 2 illustrates an exemplary embodiment of a workflow 200 for performance problem localization in an enterprise system.

FIG. 3 illustrates an exemplary embodiment of the average percent of false positives and false negatives generated by the learning method of this invention.

FIG. 4 illustrates an exemplary embodiment of average precision values for ranking weight thresholds.

FIG. 5 illustrates an exemplary embodiment of the precision scores for three values of the learning threshold.

### DETAILED DESCRIPTION

Overview

Where reference is made in any one or more of the accompanying drawings to steps and/or features, which have the same reference numerals, those steps and/or features have for the purposes of this description the same function(s) or operation(s), unless the contrary intention appears. The term “fault” and “root cause” are used synonymously. The term co-occurrence score is represented c-score. The term relevance score is represented by r-score. The term alarms and alarm patterns are used synonymously. Other equivalent expressions to the above expression would be apparent to a person skilled in the art.

The servers and/or the central controller in the enterprise system preferably include and are not limited a variety of portable electronic devices such as mobile phones, personal digital assistants (PDAs), pocket personal computers, laptop computers, application servers, web servers, database servers and the like. It should be apparent to a person skilled in the art that any electronic device which includes at least a processor and a memory can be termed a client within the scope of the present invention.

Disclosed is a system and method for localization of performance problems and resolving such performance problems in an enterprise system, where the enterprise system consists of a plurality of servers coupled over a network, forming a cluster. Localization of performance problems and resolving the performance problems improves business resiliency and business productivity by saving time, cost and other business risks involved.

Enterprise System

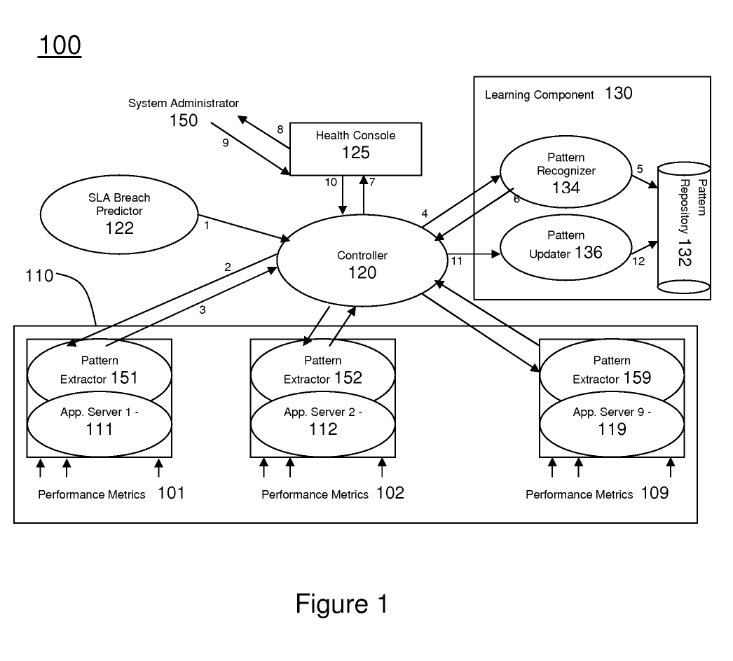

FIG. 1 illustrates an exemplary embodiment of an enterprise system 100 consisting of a central controller for localization of a performance problem and resolving the performance problem. The enterprise system consists of a cluster 110 which contains a plurality of servers 110, 111, 119 coupled to a central controller 120 via a network (not shown in the figure). The servers 111, 111, 119 can be coupled in various topologies such as mesh topology, a star topology, a bus topology, a ring topology, a tree topology or a combination thereof. Each node of the network topology can consist of a server(s). The network coupling the plurality of servers and/or the central controller is a wired network and/or a wireless network and/or a combination thereof. Each of the server(s) has a input with performance metrics 101, 102, 109. The server(s) are evaluated based on the performance metrics. Once the performance metrics are input to the server, each of the server(s) is also coupled to a pattern extractor(s) 151, 152, 159, which extracts the pattern based on the performance metric. Each of the server(s) is coupled to a central controller 120 and the central controller 120 has a health console 125 which is coupled to a learning component or learning system 130. A system administrator 150 is configured to interact with the central controller 120.

The trigger for the learning system 130 is typically from an SLA breach predictor 122 (SBP) operating at each server. The SBP triggers the learning system 130 when an abrupt change in response time or throughput in the absence of any significant change in the input load 101, 102, 109 on the server(s) 111, 111, 119 is detected. After receiving the trigger from the SBP (arrow 1, flowing from the SLA breach predictor 122 to the central controller), central controller interfaces with the server 111 which generates an alarm pattern (arrow 2) using the pattern extractor 151 based on the performance metric 101. The alarm pattern generated at the server 111 is fed to the central controller 120 (arrow 3).

On receiving the alarm pattern at the central controller, the central controller 120 feeds the alarm pattern a pattern recognizer 134 of the learning system 130 (arrow 4). The pattern recognizer 134 is interfaced with a repository 132 to match the received alarm pattern with the alarm patterns that are labeled and stored in the repository 132 (arrow 5). After the pattern recognizer 134 has matched the alarm pattern with any available alarm pattern in the repository, the pattern recognizer 134 feeds the labeled alarm patter to the central controller 120 (arrow 6).

After the alarm pattern is matched with the alarm pattern retrieved from the database, the central controller 125 then communicates with a health console (arrow 7). The health consoles 125 is interfaced with the administrator 150, typically a system administrator (arrow 8) and the administrator is configured to select the root cause for the alarm patterns that were presented to the administrator (arrow 9). In case there are no root cause(s) determined, the administrator is presented with an empty list (arrow 8) and the administrator is configured to assign a new root cause label to the alarm pattern received (arrow 9). The root cause which is identified either from the available root cause(s) presented to the administrator or a newly assigned root cause label is then sent from the health console 125 to the central controller (arrow 10). After receiving the labeled root cause(s), the central controller 120 transmits the root cause label to the pattern updater 136, which updates the root cause label in the repository 130.

A typical flow from the detection of a problem, identification of the root cause and updating the root cause label in the repository has been discussed for a single server. The same process may simultaneously take place for a number of servers coupled to the central controller.

The output from the learning system 130 is a list of faults sorted, i.e., the root cause, in order of relevance and recommended solutions to overcome the faults. This list of faults is sent to a central controller 120 which is configured to take any one of the following actions:
a. If only one server from the plurality of servers in the cluster reports a list of faults during a given time interval, a single list is displayed to the administrator along with the name and/or address of the affected server, which is a unique identifier of that server.
b. If all running servers from the plurality of servers report a list of faults during a given time interval and the most relevant fault is the same for all servers from the plurality of servers reporting the fault, it is assumed that the fault occurs typically at a resource shared by all the servers, for example a database system. The central controller 120 is then configured to choose the most relevant fault and displays the most relevant fault to the administrator.
c. A subset of running servers from the plurality of servers reports a list of faults during a given time interval, which could either be caused by multiple independent faults or by a fault that occurred on one server, and has affected the runtime metrics of other servers due to an “interference effect”. The central controller 120 treats both of these cases in the same manner and displays the lists for all affected servers.

Workflow

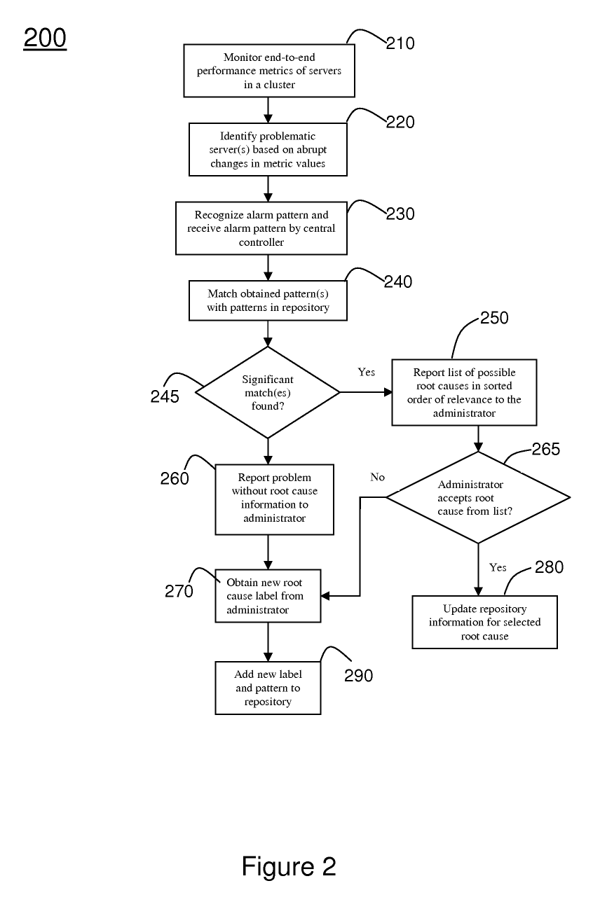

FIG. 2 illustrates an exemplary embodiment of workflow 200 for performance problem localization for an enterprise system. In 210 the plurality of servers that constitute the cluster are monitored from end-to-end for performance metrics. The monitoring is typically performed by the central controller which is coupled to the plurality of servers via a network. The network coupling the plurality of servers and/or the central controller is a wired network and/or a wireless network and/or a combination thereof.

When an abrupt change in the performance metrics value is detected, where the change is associated with a problem with at least one of the plurality of the servers in the cluster, an alarm pattern is generated by the faulty server(s), and the central controller is configured to recognize the alarm pattern that is generate within the cluster. In 220, based on the alarm pattern generated by the faulty server, the faulty server and/or faulty servers in the cluster are identified. In 230, the alarm pattern and the unique identifier of the faulty server and/or servers, for example the server address, are received by the central controller. On receiving the alarm pattern and the identifier of the faulty server, the central controller is configured to fetch from a repository a list of possible root causes associated with similar alarm pattern in an order of relevance. The order of relevance is determined by a co-occurrence and a relevance score that is computed for each of the possible root causes for the given alarm pattern.

In 240 the alarm patterns that are fetched from the repository and the received alarm pattern received from the faulty server(s) is matched. A check is then made in 245 to see if there are any significant matches between the received alarm pattern and the alarm pattern that are fetched from the repository. If any significant matches are found in 245, a report list of the possible root causes is complied and sorted in order of relevance and in 250, the list of possible root causes in order of relevance is presented to the administrator. After the list of possible root causes are presented to the administrator, in 265 a check is inserted where the administrator is configured to accept a root cause from the list of root causes and finally in 280 the administrator is configured to update the repository with the information of the selected root cause. In 265, if there are no root causes for the administrator to accept from the list of possible root causes, the control is transferred to 270 where a new root cause label is assigned to the received alarm pattern by the administrator.

If in 245 no significant matches are found, then control is transferred to 260 where a report is presented to the administrator that there have been no possible root causes identified from the alarm patterns fetched from the repository. If there are no possible root causes identified in 260, then control is transferred to 270. At 270, a new root cause label is assigned to the alarm pattern that identified the faulty server(s). After the administrator has assigned a new root cause label to the alarm pattern identified for the faulty server(s), the new label is updated into the repository. In 290, the new label and the associated alarm pattern are added to the repository. A closest possible solution associated with the root cause to the identified alarm pattern is presented to the user (e.g. the administrator) such that the proposed solution can solve the problem identified with the server(s). When a list of root causes are presented to the administrator, the associated solutions are also proposed to the administrator and the administrator is capable of identifying the root cause and the solution to the identified alarm pattern.

Once the possible root cause labels have been identified, the central controller in may be is configured to compare the list of possible solutions associated with each of the root causes and recommend a list of possible solutions that will solve the identified faulty server(s) problem. The root cause labels are identified by fetching the alarm pattern from the repository or by assigning a possible new root cause label that has been assigned by the administrator. It should be apparent to a person skilled in the art, that when more than one server(s) are faulty, then there can be more than one possible solution(s) and each of the solution(s) to solve the identified problem associated with a root cause will be different for each server(s).

Learning Component and Method—Central Controller

Assuming that two faults will occur simultaneously, the learning method of the enterprise system operates on the premise that when a fault occurs in a system, it is usually associated with a specific pattern of events. In the enterprise system 100, these events typically correspond to abrupt changes in performance metrics of the server(s).

The input to our learning method of the enterprise system 100 consists of:
a. A sequence of time-stamped events representing change point based alarms that arise from each application server in a clustered system;
b. Times of occurrence of faults at a given application server;
c. Input from a system administrator who correctly labels a fault when it occurs for the first time, or when the method fails to detect it altogether;
d. Feedback from a system administrator to verify the correctness of our output.
Two scores are computed by the learning component in the central controller, i.e., co-occurrence score and relevance score and these computed scores are used to match the received alarm pattern with the alarm patterns fetched from the repository.

The Co-Occurance and Relevance Score

For every alarm pattern that is raised within a fixed time window around the occurrence of a fault associated with a faulty server(s) a co-occurrence score is computed. For a fault F, the c-score measures the probability of an alarm pattern A being triggered when F occurs. The c-score is computed as follows:

$$c = \frac{\# ( A \& F )}{\# F} \qquad ( 1 )$$

In Eq. (1), the expression # (A & F) is the number of times A is raised when F occurs; and the expression # F is the total number of occurrences of F. The c-score for an alarm-fault pair ranges from a lowest value of 0 to a highest value of 1. A high c-score indicates a high probability of A occurring when F occurs.

Similarly, just as the co-occurrence score is computed, a relevance score can also be computed for every single alarm that is encountered. The r-score for an alarm is a measure of the importance of the alarm pattern as a function of the fault indicator. An alarm pattern has a high relevance if it usually occurs only when a fault occurs. The r-score for an alarm A is computed as follows

$$r = \frac{\# ( A \& Fault )}{\# A} \qquad ( 2 )$$

In Eq (2), the expression #(A & Fault) is the number of times A is raised when any fault occurs in the enterprise system 100, and the expression #A is the total number of times A has been raised so far. The r-score for an alarm pattern again ranges from a low value of 0 to the highest value of 1. Noticeably, the r-score is a global value for the alarm pattern i.e. there is just one r-score for an alarm pattern unlike the c-score which is determined per alarm-fault pair. The assumption made here is that the enterprise system 100 runs in a normal mode more often than it does in faulty mode. When this situation is true, alarms raised regularly during normal operation have low r-scores, while alarms raised only when faults occur have high r-scores.

Learning and Matching Algorithm

Reference is now made again to FIG. 2. The method used in the present invention, uses a repository, typically a pattern repository, to store patterns that it learns over a time. The repository is initially empty. Patterns with associated root causes are added to the repository based on administrator feedback. If a fault occurs when the repository is empty, the method is configured to notify the administrator that a fault has occurred and that the repository is empty. After locating and/or assigning the root cause to the alarm pattern, the administrator provides a new fault label to the alarm pattern which is then added by the administrator to the repository. The method is then configured to record the alarm pattern observed around the fault, along with the fault label, as a new signature. Each alarm pattern in this signature is assigned a c-score of 1.

Algorithm

For every subsequent fault occurrence, the present method uses the following procedure in order to attempt a match with fault patterns that exist in the repository. Assume that S_{F} is the set of all the faults that are currently recorded in the repository. For each fault FεS_{F}, let S_{AF} represent the set of all the alarms A that form the problem signature for the fault F.

Let each alarm AεS_{AF} have a c-score C_{AlF}, when associated with a fault F. Also, the set of alarms associated with the currently observed fault in the system is assumed to be S_{C}. For each fault FεS_{F}, the learner, which is here the central controller, computes two values
a degree of match and
a mismatch penalty.
The degree of match rewards F for every alarm in S_{C} that also occurs in S_{AF}. The mismatch penalty penalizes F for every alarm in S_{C} that does not occur in S_{AF}.

To compute the degree of match for a fault FεS_{F}, the learning method in the central controller first obtains an intersection set S_{CF}—a set of alarms common to S_{AF} and S_{C} i.e.,

S_{CF}=S_{AF}∩S_{C}. (3)

Subsequently the degree of match D_{F} is computed using:

$${D}_{F} = \frac{\sum {C}_{A 1 F} ∀ A ∈ {S}_{CF}}{\sum {C}_{A 1 F} ∀ A ∈ {S}_{AF}} \qquad ( 4 )$$

In Eq (4), the numerator in the above formula is the sum of the c-scores of alarms in the intersection set S_{CF}, and the denominator is the sum of the c-scores of alarms in S_{AF}. The ratio is thus a measure of how well S_{C} matches with S_{AF}. When a majority of alarms (that have a high c-score) in S_{AF} occur in S_{C}, the computed value of D_{F} is high.

To compute the mismatch penalty for a fault FεS_{F}, the learning method first obtains a difference set S_{MF}—a set of alarms that are in S_{C} but not in S_{AF}

S_{MF}=S_{C}−S_{AF} (5)
It then computes the mismatch penalty as follows

$${M}_{F} = 1 - \frac{\sum {R}_{A} ∀ A ∈ {S}_{MF}}{\sum {R}_{A} ∀ A ∈ {S}_{C}} \qquad ( 6 )$$

In Eq (6), the numerator in the second term for the M_{F} formula is the sum of the r-scores of alarms in S_{MF}, and the denominator is the sum of the r-scores of alarms in S_{C}. By definition, the r-score is high for relevant alarms and low for irrelevant alarms. Hence, if there are mostly irrelevant alarms are in S_{MF}, the ratio in the second term would be very low and M_{F} would have a high value.
Using D_{F} and M_{F} a final ranking weight W_{F} for a fault F is computed as:

W_{F}=D_{F}*M_{F} (7)
Eq (7), computes the ranking weights for all faults in the repository, and then presented to the administrator is a sorted list of faults with weights above a pre-determined threshold. If no fault in the repository has a weight above the threshold, its central components reports that there is no match.

The administrator uses this list to locate the fault causing the current performance problem. If the actual fault is found on the list the administrator accepts the fault. This feedback is used by the learning method of this invention to update the c-scores for all alarms in S_{C} for that particular fault. If list does not contain the actual fault, the administrator rejects the list and assigns a new label to the fault. The learner then creates a new entry in the pattern repository, containing the alarms in S_{C}, each with a c-score of 1.

Matching Algorithm Example

Consider an example that explains the functioning of the method of the present invention. Assume that S_{F} is the set of faults currently in the fault repository and S_{F}={F₁, F₂, F₃}. These faults have the following signatures stored as sets of alarm and c-score pairs. S_{AF1}={(A₁,1.0), (A₂,1.0), (A₃,0.35)}, S_{AF2}={(A₂,0.75), (A₄,1.0), (A₅,0.75)} and
S_{AF3}={(A₅,0.6), (A₆,1.0), (A₇,0.9)} Suppose a fault is now observed with a set of alarms S_{C}={A₁, A₂, A₄, A₆}. Assume that the r-scores of these alarms are R_{A1}=0.4, R_{A2}=1.0, R_{A4}=0.9, R_{A6}=0.45.

The intersection of the alarms in S_{C} with S_{AF1}, S_{AF2} and S_{AF3} yields the sets S_{CF1}={A₁, A₂}, S_{CF2}={A₂, A₄} and S_{CF3}={A₆} The degree of match for each problem signature is computed as

$$\begin{matrix}{D}_{F 1} = \frac{1.0 + 1.0}{1.0 + 1.0 + 0.35} = 0.85 , & ( 8 ) \\ {D}_{F 2} = 0.7 \\ and & ( 9 ) \\ {D}_{F 3} = 0.4 & ( 10 )\end{matrix}$$

For mismatch penalties, we compute the difference of set S_{C} from S_{AF1}, S_{AF2}, S_{AF3} to obtain S_{MF1}={A₄, A₆}, S_{MF2}={A₁, A₆} and S_{MF3}={A₁, A₂, A₄}
The mismatch penalties are

$$\begin{matrix}{M}_{F 1} = 1 - \frac{0.9 + 0.45}{0.4 + 1.0 + 0.9 + 0.45} = 0.51 , & ( 11 ) \\ {M}_{F 2} = 0.69 \\ and & ( 12 ) \\ {M}_{F 3} = 0.16 & ( 13 )\end{matrix}$$

The ranking weights are W_{F1}=0.85*0.51=0.43, W_{F2}=0.48, WF₃=0.06. With a weight threshold of 0.4, the output list is F₂, F₁. Note that even though F₁ has a higher degree of match than F₂, F₁ is second on the list due to a higher mismatch penalty.

Evaluation and Testing

The test-bed for the present invention consists of eight machines: one machine hosting two load generators, two request router machines, three application server machines, a relational database server machine, and a machine that hosts the cluster management server. The back end servers form a cluster, and the workload arriving at the routers is distributed to these servers based on a dynamic routing weight assigned to each server. The machines running the back end servers have identical configurations. They have a single 2.66 GHz Pentium4 CPU and 1 GB RAM. The machine running the workload generators are identical except that it has 2 GB RAM. Each of the routers have one 1.7 GHz Intel® Xeon CPU and 1 GB RAM. The database machine has one 2.8 GHz Intel® Xeon CPU and 2 GB RAM. All machines run the Red Hat Linux® Enterprise Edition 3, kernel version 2.4.21-27.0.1.EL. The router and back end servers run the IBM WebSphere® middleware platform, and the database server runs DB2 8.1

Trade 6® was run on each of the servers. Trade 6® is an end-to-end benchmark that models a brokerage application. It provides an application mix of servlets, JSPs, enterprise beans, message-driven beans, JDBC and JMS data access. It supports operations provided by a typical stock brokerage application.

IBM WebSphere® Workload Simulator was used to drive the experiments. The workload consists of multiple clients concurrently performing a series of operations on their accounts over multiple sessions. Each of the clients has a think time of 1 second. The actions performed by each client and the corresponding probabilities of their invocation are: register new user (2%), view account home page (20%), view account details (10%), update account (4%), view portfolio (12%), browse stock quotes (40%), stock buy (4%), stock sell (4%), and logoff (4%). These values correspond to the typical usage pattern of a trading application.

Results of Evaluation and Testing

In order to perform a detailed evaluation of the learning method of this invention over a number of parameters and fault instances, traces are generated containing the inputs required by the method of this invention and performed an offline analysis. The only difference from an online version is that the administrator feedback was provided as part of the experimentation.

The SLA breach predictor 122 is a component that resides within one of the routers in the test-bed designed. It subscribed to router statistics and logged response time information per server at every 5 second interval. Each server in the cluster is also monitored and logged for the performance metric information. A total of 60 experiments were conducted each of duration one hour (45 minutes of normal operation followed by a fault). The five faults that were randomly inserted in the system were:
CPU hogging process at a node hosting an application server
Application server hang (created by causing requests to sleep)
Application server to database network failure (simulated using Linux IP tables)
Database shutdown
Database performance problem (created either by a CPU hog or an index drop).

A constant client load was maintained during individual experiments, and the load varied between 30 and 400 clients across each experiment. After obtaining the traces for 60 experiments, the learning and matching phase involved feeding these traces to the learning method sequentially. This phase presents a specific sequence of alarms to the learning method. In order to avoid any bias towards a particular sequence of alarms, this phase was repeated 100 times, providing a different random ordering of the traces each time. For all the experiments a c-score threshold of 0.5 is used.

False Positives Reduction

The performance of our learning method in terms of false positives and negatives is explored. The false negative count as the number of times the method does not recognize a fault is computed. However, when the method observes a fault for the first time, the method does not count the fault as a false negative. After completing all the 100 runs, the average number of false negatives is computed.

False positives occur when a newly introduced fault is recognized as an existing fault. The following methodology to estimate false positives is used. Randomly a fault F is chosen and all traces containing F from the learning phase are removed. The traces containing F are then fed to the learning method and the number of times it is recognized as an already observed fault is computed. This procedure is repeated for each fault and the average number of false positives is computed.

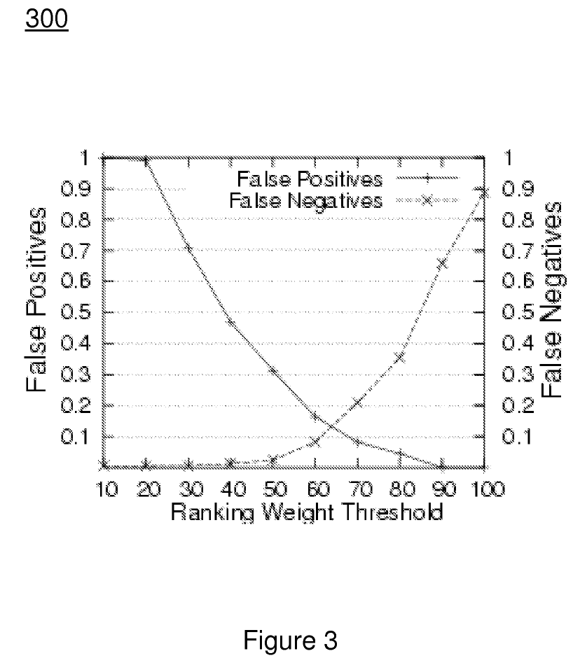

FIG. 3 shows the average percent of false positives and false negatives generated by the learning method as the ranking weight varies the threshold between 10 and 100. Recall that the ranking weight is an estimate of the confidence that a new fault pattern matches with a pattern in the repository. Only pattern matches resulting in a ranking weight above the threshold are displayed to the administrator. When the threshold is low (20% or lower) a large number of false positives are generated. This is because at low thresholds even irrelevant faults are likely to generate a match. As the threshold increases beyond 20%, the number of false positives drops steadily, and it is close to zero at high thresholds (80% or higher). Notably, the false positives are generated only when a new fault occurs in the system. Since new faults can be considered to have relatively low occurrence over a long run of a system, a false positive percent of 20-30% may also be acceptable after an initial learning period. The learning method generates few false negatives for thresholds under 50%. For thresholds in the 50-70% range, false negatives range from 3-21%. Thresholds over 70% generate a high percent of false negatives.

Hence, there is a trade off between the number of false positives and negatives. The curves for the two measures intersect when the ranking weight threshold is about 65%, and the percent of false positives and negatives is each about 13%. A good region of operation for the learning method of this invention is between a weight threshold of 50-65%, with more false positives at the lower end, and more false negatives at the higher end. An approach that can be used to obtain good overall performance is to start the learning method using a threshold close to 65%. During this initial phase, it is likely that a fault occurring in the system will be new, and the high threshold will help in generating few false positives. As the learning method learns patterns, and new faults become relatively rare, the threshold can be lowered to 50% in order to reduce false negatives.

Precision

If a fault is always detected but usually ends up at the bottom of the list of potential root causes, the analysis is likely to be of little use or no use. In order to measure how effectively the learning method matches new instances of known faults, a so called precision measure is defined. Each time our method detects a fault, we compute a precision score using the formula:

$$\frac{( \# F - i - 1 )}{\# F} \qquad ( 14 )$$

In Eq (14), #F is the number of faults in the repository, and i is the position of the actual fault in the output list. A false negative is assigned a precision of 0, and the learning method is not penalized for new faults that are not present in the repository. One hundred iterations are performed over the traces using the random orderings described above, and the average precision is computed.

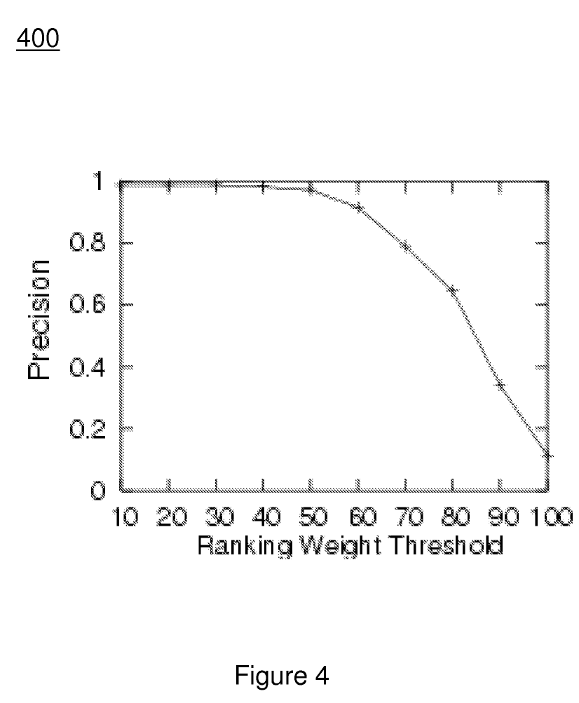

FIG. 4 illustrates an exemplary embodiment of the average precision values for ranking weight thresholds ranging from 10-100. The precision score is high for thresholds ranging from 10-60%. For thresholds ranging from 10-30%, the average precision is 98.7%. At a threshold of 50% the precision is 97%, and at a threshold of 70% the precision is 79%. These numbers correspond well with the false negative numbers presented in the previous section, and indicate that when the method detects a fault, it usually places the correct fault at the top of the list of potential faults.

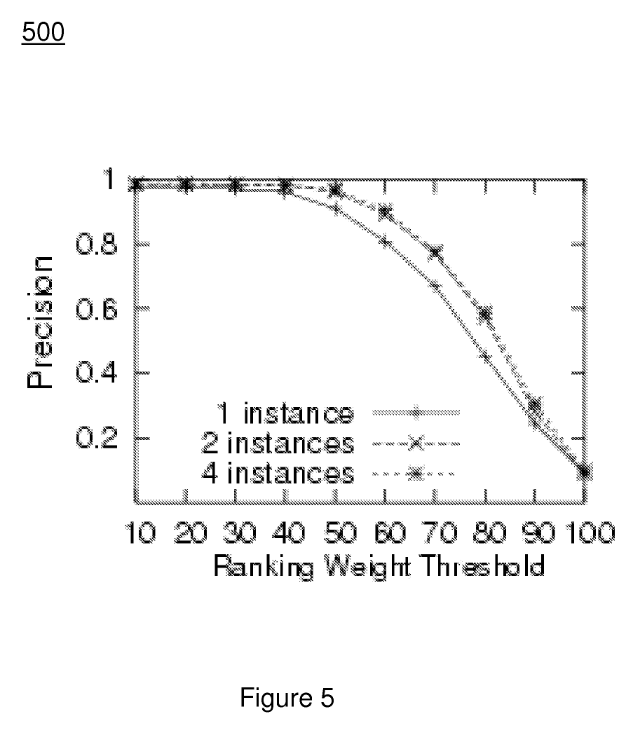

FIG. 5 illustrates an exemplary embodiment of precision scores for three values of the learning threshold, 1, 2, and 4. The precision values are shown for ranking weight thresholds ranging from 10-100. When the method is provided with only a single instance of a fault, it has precision values of about 90% when the ranking weight is 50%. This is only about 8% worse than the best possible precision score. At a ranking weight threshold of 70%, the precision is about 14% lower than the best possible precision. This data clearly shows that the learning method learns patterns rapidly, with as few as two instances of each fault required to obtain high precision. This is largely due to two reasons. First, we use change point detection techniques to generate events and we have found that they reliably generate unique patterns for different faults. Second, the c-score and the r-score used by the learning method that filter out spurious events.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

The accompanying figures and this description depicted and described embodiments of the present invention, and features and components thereof. Those skilled in the art will appreciate that any particular program nomenclature used in this description was merely for convenience, and thus the invention should not be limited to use solely in any specific application identified and/or implied by such nomenclature. Thus, for example, the routines executed to implement the embodiments of the invention, whether implemented as part of an operating system or a specific application, component, program, module, object, or sequence of instructions could have been referred to as a “program”, “application”, “server”, or other meaningful nomenclature. Indeed, other alternative hardware and/or software environments may be used without departing from the scope of the invention. Therefore, it is desired that the embodiments described herein be considered in all respects as illustrative, not restrictive, and that reference be made to the appended claims for determining the scope of the invention.

Although the invention has been described with reference to the embodiments described above, it will be evident that other embodiments may be alternatively used to achieve the same object. The scope of the invention is not limited to the embodiments described above, but can also be applied to software programs and computer program products in general. It should be noted that the above-mentioned embodiments illustrate rather than limit the invention and that those skilled in the art will be able to design alternative embodiments without departing from the scope of the appended claims. In the claims, any reference signs should not limit the scope of the claim. The invention can be implemented by means of hardware and software comprising several distinct elements.

What is claimed is:

1. A method for localization of performance problems in an enterprise system comprising a plurality of servers forming a cluster and providing possible root causes, the method comprises:
monitoring the server(s) in the cluster;
receiving an alarm pattern and a server identification of the server(s) at a central controller;
assigning a list of root cause(s) for the alarm pattern received in order of relevance;
selecting the most relevant root cause from the list of root cause(s) based on an administrator feedback; and
updating the repository with the alarm pattern and the assigned root cause label.

2. The method of claim 1, all the limitations of which are incorporated herein by reference, wherein monitoring the plurality of servers in the cluster further comprising
polling the plurality of server in the cluster based on pre-defined rules; and
identifying the alarm pattern with the at least one server in the cluster.

3. The method of claim 2, all the limitations of which are incorporated herein by reference, further comprising
presenting the received alarm pattern to the administrator, wherein the received alarm pattern is associated with a faulty server(s);
fetching a list of possible root cause(s) associated with a alarm pattern in a repository, wherein the alarm patterns in the repository are labeled alarm patterns;
presenting the administrator with a list of possible root cause(s) in an order of relevance, wherein the order of relevance is determined from a computed score; and
matching the received alarm patterns with the list of possible root cause(s) that are fetched from the repository.

4. The method of claim 3, all the limitations of which are incorporated herein by reference, wherein presenting the list of possible root cause, matching the alarm patterns, assigning a root cause and updating the repository is performed without any human intervention.

5. The method of claim 1, all the limitations of which are incorporated herein by reference, wherein assigning the list of root cause(s) further comprises
assigning a new root cause label for the alarm pattern when the received alarm pattern is not recorded present in the repository based on the administrator feedback.

6. The method of claim 1, all the limitations of which are incorporated herein by reference, wherein recommending at least one root cause in order of relevance comprises computing a score.

7. The method of claim 1, all the limitations of which are incorporated herein by reference, further comprises
associating possible root cause(s) with the faulty server(s); and
displaying the faulty server(s) identity with the most likely root cause for the alarm pattern.

8. An enterprise system comprising a plurality of servers forming a cluster coupled via a network, each of the server(s) configured to perform identified tasks, the cluster comprising a central controller configured to control and monitor each of the server(s) in the cluster, identify an alarm pattern in at least one faulty server(s) in the cluster and the central controller further configured to identify and recommend a list of possible root cause(s) in order of relevance to the administrator for selecting the most likely root cause(s) and updating the repository with alarm pattern and the associated most likely root cause(s) associated.

9. The system of claim 8, all the limitations of which are incorporated herein by reference, wherein the central controller is configured to receive the alarm pattern from a faulty server(s) in the cluster.

10. The system of claim 8, all the limitations of which are incorporated herein by reference, wherein the central controller is configured to retrieve a list of possible root cause(s) associated with labeled alarm patterns from a repository.

11. The system of claim 10, all the limitations of which are incorporated herein by reference, wherein the central controller comprises a learning component configured to match the received alarm pattern with labeled alarm patterns in a repository and assign possible root cause(s) and a root cause label to the received alarm pattern.

12. The system of claim 11, all the limitations of which are incorporated herein by reference, wherein the learning component is configured to compute a score for the retrieved alarm patterns from the repository and rank the retrieved alarm pattern and possible root cause(s) associated with the retrieved alarm pattern in order of relevance.

13. The system of claim 8, all the limitations of which are incorporated herein by reference, wherein the central controller is configured to interact with an administrator to obtain human feedback on the possible root cause for the received alarm pattern and associate the received alarm pattern with an existing labeled alarm pattern in the repository.

14. The system of claim 8, all the limitations of which are incorporated herein by reference, wherein the central controller is configured to update the repository.

15. The system of claim 13, all the limitations of which are incorporated herein by reference, wherein the central controller is configured to assign the possible root cause for the received alarm pattern without any human intervention.

16. A method for deploying computing infrastructure, comprising integrating readable code into a computing system, wherein the readable code in combination with the system is capable of performing a method of:
monitoring the server(s) in the cluster;
receiving an alarm pattern and a server identification of the server(s) at a central controller;
assigning a list of root cause(s) for the alarm pattern received in order of relevance;
selecting the most relevant root cause from the list of root cause(s) based on an administrator feedback; and
updating the repository with the alarm pattern and the assigned root cause label.
